(19) United States
(12) Patent Application Publication
(10) Pub. No.: US 2012/0066958 A1
(43) Pub. Date: Mar. 22, 2012

(54) Insect trap

(76) Inventor: Charles Alan McGinnis, JR., Midland, MI (US)

(21) Appl. No.: 12/807,899

(22) Filed: Sep. 16, 2010

(51) Int. Cl. A01M 1/08; A01M 1/04; A01M 1/06

(52) U.S. Cl. 43/113; 43/107; 43/139

(57) ABSTRACT

An insect trap that uses light, a baited area and a timer to attract, incapacitate and kill insects. The trap is used to capture insects by attraction to a light source and/or a bait source. When the insects are investigating the light and or the baited area, a timer energizes a fan that draws the insects into its blades incapacitating the insects and dropping them into a removable tray. The tray is then dumped and the device is ready for the next cycle.

### BACKGROUND OF THE INVENTION

The instant device is an insect trap that is a combination of a receptacle, an attractant, a kill method and a timer. The attractant draws insects to the trap, and then a timer starts a fan that thaws the insects into the trap and kills them in the fan blades. The remains fall to a removable tray for their disposal. The ability of the timer to pause the operation long enough to give the insect a false sense of security is key.

Many insect traps use attractants and kill methods, but none combine the use of the attractant and a timer. The device is set up to capture the desired pest from a list that includes but is not limited to: fruit flies, house flies, bees, horse flies, deer flies, mosquitoes, black flies, flying insects, insects and ants.

### THE INVENTION

The instant invention is an automated insect trap comprising: a first housing that has a top, a bottom, a front, two opposing sides and an elevated base. This top has a large intake opening therethrough.

The insect trap has a second housing located within the first housing comprising an open-ended conduit beginning at the top of the intake opening and extending to an exit opening in the bottom of the first housing.

The intake opening has a bait insert area located therein. This bait insert area allows for the positioning of insect bait therein. The bait insert area allows the passage of air therethrough. There is fixedly attached to the interior of the open ended conduit, an electric fan positioned such that any air moved by the fan is pulled through the top of the first housing and exits below the fan. There is also a means of electrically powering the electric fan. The fan is equipped with a repeating cycle timer, a means of electrically powering the repeating cycle timer and a collection area at the exit opening of the first housing and within the elevated base.

### BRIEF DESCRIPTION OF THE DRAWINGS

FIG. 1 is a full front view of the insect trap of this invention.

FIG. 2 is a cross sectional view of the device of FIG. 1 through the line A-A of FIG. 1.

FIG. 3 is a side view of the top of the insect trap.

FIG. 4 is a side view of the bait of the insect trap.

FIG. 5 is a side view of the light of the insect trap.

FIG. 6 is a top view of the fan of the insect trap.

FIG. 7 is a side view of the light of the trap.

### DETAILED DESCRIPTION OF THE DRAWINGS

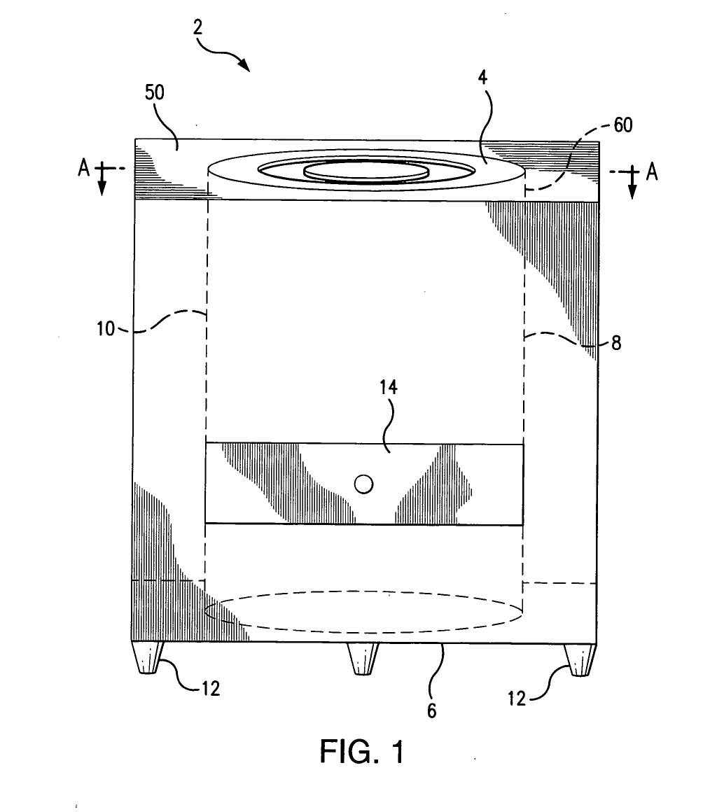

FIG. 1 is a front view of the insect trap 2. The top 4 has an opening 16 where the flies are drawn into the trap 2. The trap 2 uses a fan 18, not shown, to draw the flies into the trap 2 and the air is exhausted out of the bottom 6. The trap sits on support legs 12. There is a first side 8 and a second side 10 with a removable tray 14 in the middle region of the trap 2.

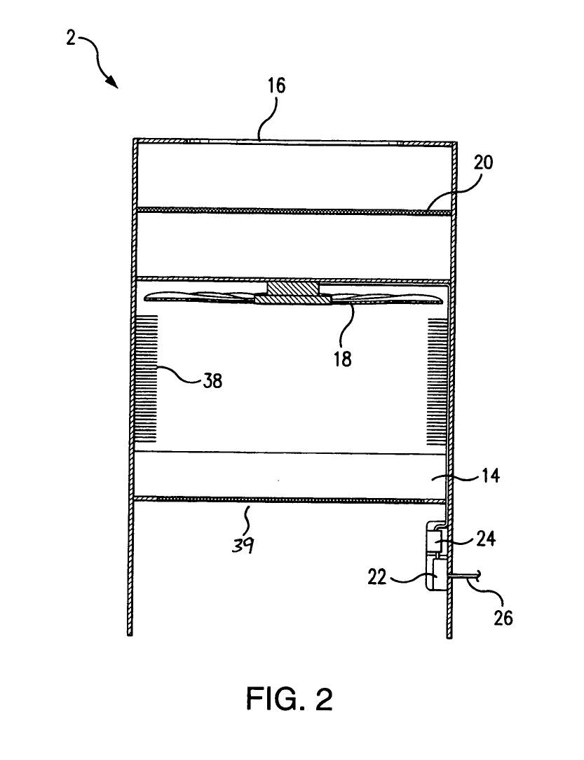

FIG. 2 is a cross sectional view of the insect trap 2 taken through line A-A of FIG. 1. This Figure shows the working components of the insect trap 2. The top 4 has an opening 16 that allows the insects to enter the top 4 of the trap 2. The insects land on the scented mesh 20 which is the bait of the trap 2. The insects are attracted to the mesh 20 where they land until the fan 18 is turned on by the timer 22 that is controlled by a switch 24. The system is energized by the power cord 26. It should be known that this is the preferred embodiment. There are many alternative means to power the system including but not limited to batteries, solar panels, rechargeable batteries and any other means of electrical energy. The fan 18 is supported by a support system that attaches to the first side 8 and the second side 10 that will support the fan 18 and its wiring in a centralized location within the trap 2.

When the fin 18 is energized the blades 30 rotate and cause a down draft or suction on the scented mesh 20, pulling the insects through the mesh 20, into the blades 30 where the insects are disabled from contact with the blades 30. The disabled or dead insects then drop into the removable tray 14 and are dumped from the trap 2. The tray 14 has a pull 32. This cycle is repeated as long as the trap 2 is energized and turned on.

The timer 22 is set to operate in short periods in the on then off position. This delayed operating period is essential to the trapping of the insects, in that the insects receive a false sense of security when the fan 18 stops allowing them to move through the opening 16 in the top 4 and onto the scented mesh 20. The timer switches on and it is too late they are drawn into the trap 2.

The inside wall 38 of the trap 2 is covered in barbs 36 that extend from the inside wall 38 out. These barbs 36 are an extra device that serves to further disable the insects. These insects then will fall into the removable tray 14. The barbs are optional in the device of the instant invention.

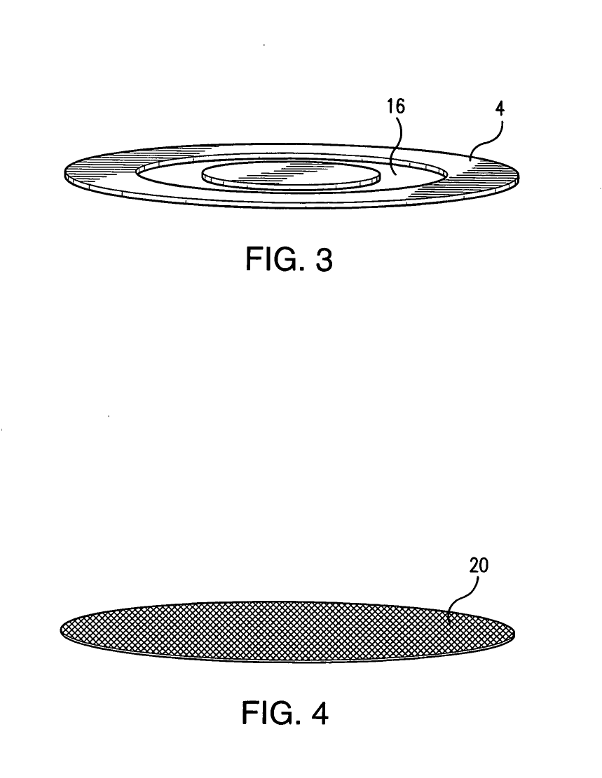

FIG. 3 is a side view of the top 4 of the insect trap 2. This is one embodiment of the top. This embodiment has an opening 16 for the insects to traverse into the trap 2 and on to the mesh 20. Alternative embodiments include but are not limited to larger or smaller openings, decorative or designer openings, company logos or any other opening that would allow the entrance of an insect.

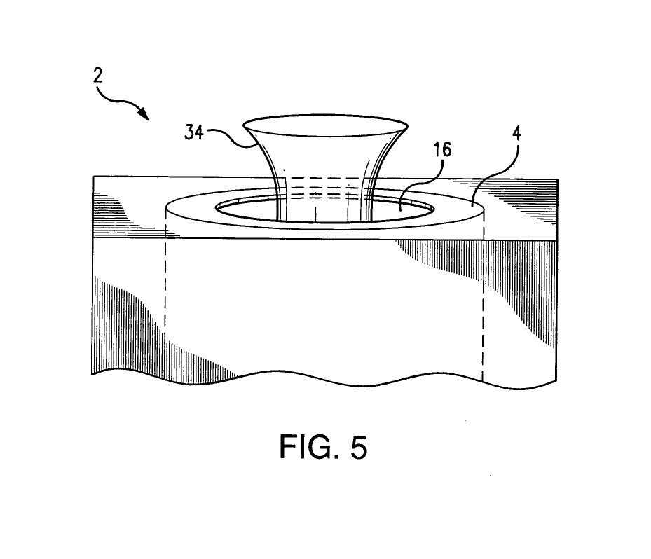

FIG. 4 is a side view of the scented mesh 20 of the insect trap 2. The mesh 20 must have size large enough to allow the passage of the insect into the blades 30 of the fan 18. The mesh 20 is also scented with any scent that would attract the desired insect to be trapped. Scents of fruit or vegetable are used to attract fruit flies for example. It has been discovered that the scents vary depending on the insect that presents the problem. The scent is chosen to draw the pest that is present or creating an issue. The size if the mesh is also dependent upon this fact. This means a larger mesh is required for larger insect and smaller mesh is sufficient for smaller insects.

FIG. 5 is a side view of the light 34 of the insect trap 2. The trap 2 can also include the use of a light source as an extra attractant to increase the efficiency of the trap 2. The light 34 in this embodiment is affixed to an area adjacent to the opening 16 in the top 4. This light is a standard low watt light. The light in other embodiments include one mounted below the opening 16 to draw the insects into the area near the mesh. It should also be known that the light can be of various wattages.

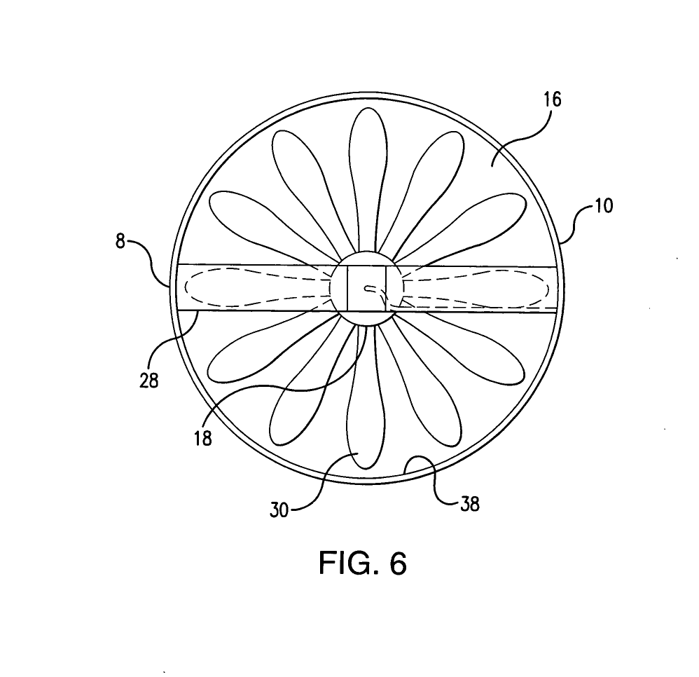

FIG. 6 is a top view of the fan 18 of the insect trap 2. This view shows the fan supports 28 mounted to the inside wall 38 that suspend the fan 18 with its blades 30. The supports 28 are mounted one the inside wall 38 of the first side 8 and the second side 10. The fan 18 has a plurality of blades 30 that serve to incapacitate the insects once they are pulled through the opening 16 by the suction of the fan 18.

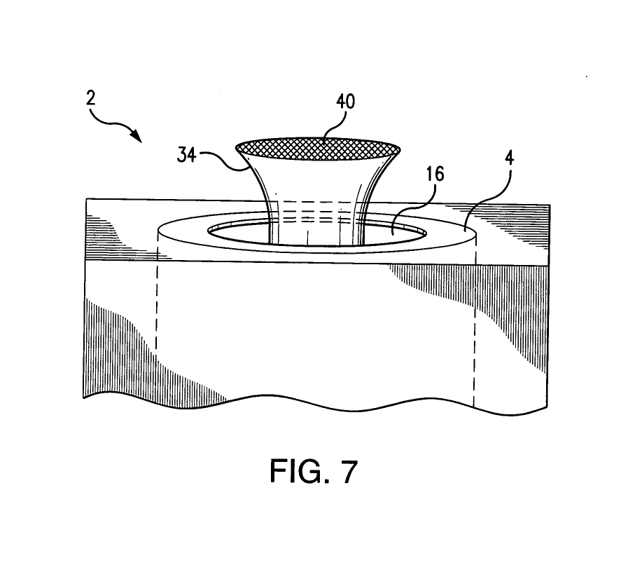

FIG. 7 is a side view of the light 34 of the trap 2. This embodiment contains a solar panel 40 in light 34. This solar panel 40 runs the light 34. The electrical system of the trap 2 is also configured to use a solar panel 34 to recharge chargeable batteries 42 in a battery charger 44 and run the entire trap 2.

With the timer set to the desired time and the bait in place, the invention is ready for use. The insect in question is drawn to the trap and begins to feed on the bait. Then the timer initiates the beginning of the cycle. The timer starts the fan that draws the insect into the turning blades of the fan, killing or maiming them. The insects then fall to the removable tray. The timer stops. There is a time lapse that is predetermined and set by the user giving more insects if they are present, time to move into the bait area and the cycle repeats itself. The removable tray is removed and the dead insects are disposed of at will.

Another unique feature of the insect trap is when in operation the fan disperses the scent out of the bottom of the trap. Other prior art trap disperse the scent through the top creating an air flow that the insects must fly against in order to reach the trap. The instant invention does not hamper the insects approach.

The device is set up to capture a desired pest that list includes but is not limited to: fruit flies, house flies, bees, horse flies, deer flies, mosquitoes, black flies, flying insects, insects and ants.

In the preferred embodiment the fan runs from about 5 to 30 seconds killing the insects. Other embodiments require larger fans and variable timing to kill larger insects. Larger units are required for commercial or industrial applications.

Still other embodiments are battery powered for portability.

What is claimed is:

1. An automated insect trap, said trap comprising:
a. a first housing, said housing having a top, a bottom, a front, two opposing sides and an elevated base; said top having a large intake opening therethrough;
b. a second housing located within the first housing comprising an open-ended conduit beginning at the top of the intake opening and extending to an exit opening in the bottom of the first housing;
c. said intake opening having a bait insert area located therein, said bait insert area allowing for the positioning of insect bait therein, said bait insert area allowing the passage of air therethrough;
d. fixedly attached to the interior of the open ended conduit, an electric fan positioned such that any air moved by the fan is pulled through the top of the first housing and exits below the fan;
e. a means of electrically powering the electric fan;
f. electrically connected to said electrical fan, a repeating cycle timer,
g. a means of electrically powering the repeating cycle timer,
h. a collection area at the exit opening of the first housing and within the elevated base.

2. The insect trap as claimed in claim 1 wherein there is, in addition, a light source surmounting the first housing.

3. The insect trap as claimed in claim 2 wherein the light source is solar powered.

4. The insect trap as claimed in claim I wherein the collection area consists of a moveable drawer having a mesh bottom covering.

5. The insect trap as claimed in claim 1 wherein the electrical power to the fan is provided by at least one battery.

6. The insect trap as claimed in claim 1 wherein the electrical power to the fan is provided by ac or dc current.

7. The insect trap as claimed in claim I wherein there is, in addition, a plurality of barbs positioned perpendicular on the interior wall of the second housing.

8. The insect trap as claimed in claim 1 wherein the trap is configured to capture fruit flies.

9. The insect trap as claimed in claim 1 wherein the trap is configured to capture house flies.

10. The insect trap as claimed in claim 1 wherein the trap is configured to capture bees.

11. The insect trap as claimed in claim I wherein the trap is configured to capture horse flies.

12. The insect trap as claimed in claim 1 wherein the trap is configured to capture deer flies.

13. The insect trap as claimed in claim 1 wherein the trap is configured to capture mosquitoes.

14. The insect trap as claimed in claim I wherein the trap is configured to capture black flies.

15. The insect trap as claimed in claim I wherein the trap is configured to capture flying insects.

16. The insect trap as claimed in claim 1 wherein the trap is configured to capture insects.

17. The insect trap as claimed in claim 1 wherein the trap is configured to capture ants
